(19) United States
(12) Patent Application Publication
(10) Pub. No.: US 2008/0006352 A1
(43) Pub. Date: Jan. 10, 2008

(54) MAGNETIC SHEET AND METHOD OF PRODUCING THE SAME

(75) Inventors: Hisato Koshiba, Niigata-ken (JP); Kinsiro Takadate, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/767,340

(22) Filed: Jun. 22, 2007

(30) Foreign Application Priority Data
Jun. 29, 2006 (JP) 2006-180298

(51) Int. Cl. H01F 1/00; C22C 45/00

(52) U.S. Cl. 148/561; 148/304

(57) ABSTRACT

The magnetic sheet according to the present invention includes a resin and soft magnetic particles contained in the resin. The soft magnetic particles characteristically contain crystallites in an amorphous phase in a relatively small amount. The magnetic sheet can be obtained by producing soft magnetic particles consisting of an amorphous phase, producing a magnetic sheet containing the soft magnetic particles, and producing crystallites in the amorphous phase by annealing the magnetic sheet at a temperature of approximately the glass-transition temperature or approximately the crystallization temperature of the material constituting the soft magnetic particles.

### CLAIM OF PRIORITY

This application claims benefit of the Japanese Patent Application No. 2006-180298 filed on Jun. 29, 2006, which is hereby incorporated by reference.

### BACKGROUND OF THE INVENTION

1. Field of the Invention

The present invention relates to a magnetic sheet used as a noise suppression sheet and relates to a method of producing the same.

2. Description of the Related Art

Recently, portable electronic devices, as represented by mobile phones and notebook computers, are broadly used. These portable electronic devices have the problem of electromagnetic interference. In particular, it has been necessary to prevent undesired radio waves of high frequencies. In order to suppress the undesired radio waves, it is preferable to use a magnetic composite having a large imaginary part μ″ of complex magnetic permeability in the frequency band to be used. Consequently, a magnetic sheet made of a material in which a powder constituted of a soft magnetic alloy such as an Fe—Al—Si alloy or an Fe—Ni alloy is dispersed has been developed.

For example, in Japanese Unexamined Patent Application Publication No. 2000-068117, an electromagnetic wave absorber is obtained by mixing a soft magnetic alloy powder having a flat shape with a matrix material and injection molding the resulting mixture. In this electromagnetic wave absorber, the imaginary part μ″ of complex magnetic permeability is increased by orienting the flat soft magnetic alloy powder in one direction by the injection molding and thereby improving the filling factor of the soft magnetic alloy powder.

However, in the above-described electromagnetic wave absorber, it is difficult to increase the imaginary part μ″ of complex magnetic permeability in a specific frequency range from MHz to GHz bands, particularly, from 100 to 800 MHz in which noise problems tend to occur. Hence, the electromagnetic wave absorber has a problem that the noise-suppressing effect cannot be achieved in a specific frequency range in 100 to 800 MHz (for example, from 200 to 300 MHz).

### SUMMARY OF THE INVENTION

The present invention provides a magnetic sheet having an excellent noise-suppressing effect in a specific frequency range from MHz to GHz bands, particularly, 100 to 800 MHz in which noise problems tend to occur. The present invention also provides a method of producing such a magnetic sheet.

The magnetic sheet according to the present invention contains a matrix material and a magnetic material contained in the matrix material. In the magnetic material, an amorphous phase contains a relatively small amount of crystallites which, preferably, are bcc-Fe or consist mainly of bcc-Fe.

With such constitution, the amorphous phase contains crystallites, the amount of which is relatively smaller than that of the amorphous phase. Therefore, the real part μ′ of complex magnetic permeability at a frequency up to about 10 MHz and the imaginary part μ″ of complex magnetic permeability at a frequency of 200 to 300 MHz are increased. The thus increased imaginary part μ″ of complex magnetic permeability enhances the ability for converting radio waves to heat. Consequently, the noise-suppressing effect can be improved. In addition, since the amorphous phase has a high electric resistance, the μ′ and the μ″ can be readily maintained in a high-frequency band. Further, in this structure, since the crystallites are partially deposited, the advantage of the characteristically high electric resistance of the amorphous phase can be still utilized.

In the magnetic sheet according to the present invention, the crystallites are preferably produced by annealing the magnetic material at a temperature of approximately the glass-transition temperature or approximately the crystallization temperature of the magnetic material.

In the magnetic sheet according to the present invention, the magnetic material is preferably an Fe-based soft magnetic alloy.

A method of producing a magnetic sheet according to the present invention includes a process of producing a magnetic material consisting of an amorphous phase, a process of producing a magnetic sheet containing the magnetic material, and a process of producing crystallites in the amorphous phase by annealing the magnetic sheet at a temperature of approximately the glass-transition temperature or approximately the crystallization temperature of the magnetic material.

In the method of producing a magnetic sheet according to the present invention, the magnetic material consisting of the amorphous phase is preferably produced by a water atomization method.

In the method of producing a magnetic sheet according to the present invention, the magnetic sheet is preferably produced by preparing a mixture solution by mixing the magnetic material in a liquid matrix material for constituting the magnetic sheet and then forming the mixture solution into a sheet.

In the annealing, crystallites of bcc-Fe or consisting mainly of bcc-Fe are preferably deposited. The annealing temperature is about 325 to about 400° C., more preferably about 350 to about 375° C.

### BRIEF DESCRIPTION OF THE DRAWINGS

FIG. 1A is a cross-sectional view of a magnetic sheet according to an embodiment of the present invention.

FIG. 1B is a diagram illustrating a noise-suppressing effect in the magnetic sheet.

FIGS. 2A to 2G are diagrams illustrating a method of producing a magnetic sheet according to an embodiment of the present invention.

FIG. 3 is a graph showing X-ray diffraction patterns when annealing is carried out at different annealing temperatures.

FIG. 4 is a graph showing a temperature profile in annealing.

FIG. 5A is a graph showing an evaluation result of a digital still camera in accordance with the specification of VCCI class B.

FIG. 5B is a graph showing an evaluation result of a digital still camera in accordance with the specification of VCCI class B.

FIG. 6 is a characteristics diagram showing the relationships between imaginary parts μ″ and frequencies.

FIG. 7 is a diagram showing noise attenuation in car navigation systems of which CPU clocks provided with magnetic sheets.

### DESCRIPTION OF THE PREFERRED EMBODIMENTS

The present invention will now be described in detail with embodiments referring to the attached drawings.

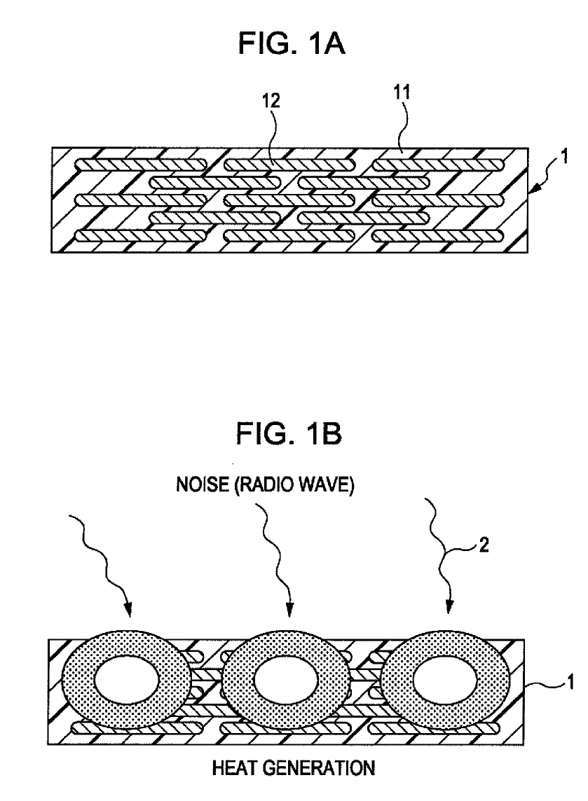

FIG. 1A is a cross-sectional view illustrating a magnetic sheet according to a first embodiment of the present invention. The magnetic sheet 1 according to the present invention is composed of a resin 11 which is a matrix material functioning as a binder and soft magnetic particles 12 which are a magnetic material contained in the resin 11. The soft magnetic particles 12 comprise an amorphous phase containing a relatively smaller amount of crystallites than that of the amorphous phase. With reference to FIG. 18, in the magnetic sheet 1, radio waves 2 which become noise are converted to heat, and thereby a noise-suppressing effect is achieved.

Examples of the matrix material include silicone resin, polyvinyl chloride, silicone rubber, phenol resin, melamine resin, polyvinyl alcohol, Chlorinated polyethylene and various types of elastomers. In particular, since the magnetic sheet is formed by mixing a magnetic material in a resin solution, the matrix material is preferably resin, such as silicone resin, which can give an emulsion solution of a magnetic material. In addition, the magnetic material can be readily processed into a flat shape by adding a lubricant containing stearate or the like to the matrix material. Then, a magnetic material having a high aspect ratio can be obtained. Consequently, the magnetic material of the magnetic sheet tends to be laminated and oriented in the thickness direction of the sheet, and therefore the density becomes high. As a result, the imaginary part μ″ of complex magnetic permeability is increased and thereby the noise suppression property can be improved.

The magnetic material contained in the matrix material is preferably particles or powder constituted of a soft magnetic material. The magnetic material used in the magnetic sheet according to the present invention is preferably flat particles or powder. The flat particles and powder having an aspect ratio (major axis/thickness) of about 2.5 or more, preferably about 12 or more, are preferable from the viewpoints of orientation and noise suppression property. The improvement of the orientation of flat particles or powder allows the density of the magnetic sheet itself to be increased and the imaginary part μ″ of complex magnetic permeability to be increased, and thereby the noise suppression property is improved. In addition, when the aspect ratio is high, the occurrence of eddy current is suppressed and the impedance is increased. Consequently, the imaginary part μ″ of complex magnetic permeability in a GHz band is increased.

The soft magnetic material is preferably an Fe-based soft magnetic alloy, the main phase of which is an amorphous phase having a reduced vitrification temperature Tx/Tm (Tx: crystallization initiating temperature, Tm: melting temperature) of about 0.55 or more or Fe-based metal glass, the main phase of which is an amorphous phase having a temperature interval ΔTx of supercooled liquid, represented by a formula ΔTx=Tx−Tg (Tx: crystallization initiating temperature, Tg: glass transition temperature), being about 25 K or more. More specifically, the soft magnetic material is preferably a material constituted of an amorphous phase, the main component of which is Fe and which contains at least P, C, and B. Examples of such a material include an Fe—Ni—Cr—P—C—B—Si alloy.

Such an amorphous soft magnetic alloy is metal glass having a temperature interval ΔTx of supercooled liquid being about 25 K or more. In some compositions, the ΔTx is about 30 K or more and, further, is significantly large such as about 50 K or more. In addition, the amorphous soft magnetic alloy exhibits excellent soft magnetic properties at room temperature.

The magnetic material is basically constituted of an amorphous phase which contains crystallites in a relatively smaller ratio than that of the amorphous phase. That is, an amorphous phase rich is formed in the amorphous phase and the crystallites.

The magnetic material consisting of an amorphous phase has relatively large magnetostriction. In the process of producing crystallites in an amorphous phase, the drastic change from an amorphous phase to a crystalline phase takes place. In an Fe-rich alloy, Fe-based crystallites are deposited. At this occasion, it is preferable that only Fe crystals having a bee structure be formed in the crystallite phase. Since the deposition of a compound phase, such as an Fe—B phase or Fe—P phase, decreases the magnetic permeability μ, the deposition of a compound phase should be avoided as much as possible. Since the crystallite phase of a bcc-Fe phase has negative magnetostriction, the magnetic permeability p will be increased by the compensation of the positive magnetostriction of the amorphous phase. Thus, the magnetic permeability μ is increased by a decrease in the magnetostriction of a magnetic material consisting of an amorphous phase, and consequently the imaginary part μ″ of complex magnetic permeability is increased. The magnetic sheet according to the present invention has a high imaginary part μ″ of complex magnetic permeability in a specific frequency range from MHz to GHz bands (for example, from about 200 to about 300 MHz), particularly, from about 100 to about 800 MHz in which noise problems tend to occur.

Thus, in the magnetic sheet according to the present invention, the magnetostriction is decreased by that the amorphous phase contains crystallites. Further, the imaginary part μ″ of complex magnetic permeability in a range from MHz to GHz bands, particularly, in a specific frequency range from about 100 to about 800 MHz in which noise problems tend to occur can be increased by keeping the electric resistance of the amorphous phase high. In addition, since the magnetic material is insulated by the matrix material, the impedance of the magnetic sheet itself can be increased. With this, the occurrence of eddy current is suppressed, and the imaginary part μ″ of complex magnetic permeability in a range from MHz to GHz bands can be increased in a broad range. Thus, the noise-suppressing effect can be improved in a high-frequency band. When the imaginary part μ″ of complex magnetic permeability is thus increased, the ability for converting radio waves to heat is increased. Consequently, the noise-suppressing effect can be improved.

A method of producing a magnetic sheet according to the present invention includes a process of producing a magnetic material consisting of an amorphous phase, a process of producing a magnetic sheet containing the magnetic material particles, and a process of producing crystallites of mainly bcc-Fe in the amorphous phase by annealing the magnetic sheet at a temperature of approximately the glass-transition temperature or approximately the crystallization temperature of the magnetic material.

First, the magnetic material consisting of an amorphous phase, for example, a soft magnetic alloy powder is prepared. In this case, the soft magnetic alloy powder is prepared by a water atomization method by weighing raw materials so as to give the composition of the soft magnetic alloy powder, mixing and melting the raw materials, and ejecting the resulting alloy melt into water for quenching. The method of producing a magnetic material consisting of an amorphous phase is not limited to the water atomization method. A gas atomization method or a liquid quenching method may be employed. In the liquid quenching method, ribbon obtained by quenching the above-mentioned alloy melt is pulverized into powder. The water atomization method, gas atomization method, or liquid quenching method can be carried out under conditions which are usually employed depending on the raw materials.

The obtained amorphous soft magnetic alloy powder is classified to have a uniform particle size. Then, if needed, the alloy powder is processed into a flat shape with a device such as an attritor. The attritor is a device in which a large number of mill balls are placed in a drum. The soft magnetic alloy powder is processed to a desired degree of flatness by stirring and mixing the soft magnetic alloy powder put in the drum and the balls with a stirring rod inserted so as to be rotatable around the axis of the drum. In addition, the flat particles of the soft magnetic alloy powder can be also obtained by the above-mentioned liquid quenching method. Further, the obtained soft magnetic alloy powder may be treated with heat in order to decrease the internal stress, if necessary.

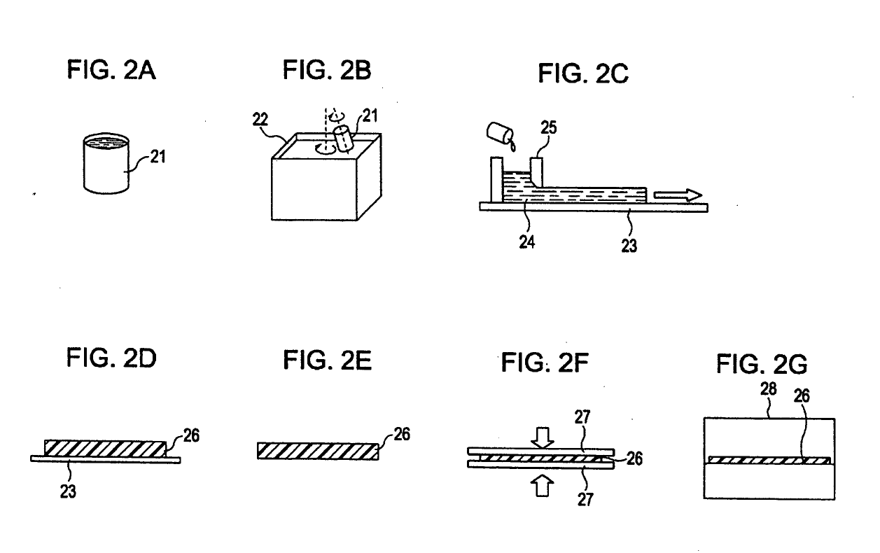

Then, a magnetic sheet containing magnetic material particles is produced. In this case, it is preferable to produce the magnetic sheet by preparing a mixture solution by mixing magnetic particles in a liquid matrix material and then processing the mixture solution into a sheet. For example, an amorphous soft magnetic alloy powder as the magnetic material, a resin as the matrix material, and a solvent are put into a stirring vessel 21 shown in FIG. 2A. Then, as shown in FIG. 2B, this stirring vessel 21 is mounted on a planetary stirring defoaming device 22, and slurry of the mixture solution is mixed and defoamed for slurry adjustment. Examples of the solvent include xylene, toluener and isopropyl alcohol.

Then, as shown in FIG. 2C, the slurry 24 is applied onto a release film 23 with a doctor blade 25 and then dried for curing. With this, a sheet 26 is formed on the release film 23 as shown in FIG. 2D. Then, as shown in FIG. 2E, the sheet 26 is peeled off the release film 23. The amorphous soft magnetic alloy powder (flat particles) contained in the slurry 24 is aligned and oriented in one direction by thus forming the slurry 24 into a sheet. That is, as shown in FIG. 1A, the major axis directions of the soft magnetic particles 12 are oriented so as to be aligned in the in-plane direction of the sheet 26.

Then, as shown in FIG. 2F, the sheet 26 is set to a pressing machine 27 and is consolidated by pressing. The pressing can be carried out under conditions for usual thermocompression. For example, the pressing may be conducted under conditions of a heating temperature of about 80 to about 160° C., a pressing pressure of about 50 to about 500 kg/cm², and a pressing time of about 5 to about 60 min. This pressing treatment is an optional process, which may not be carried out.

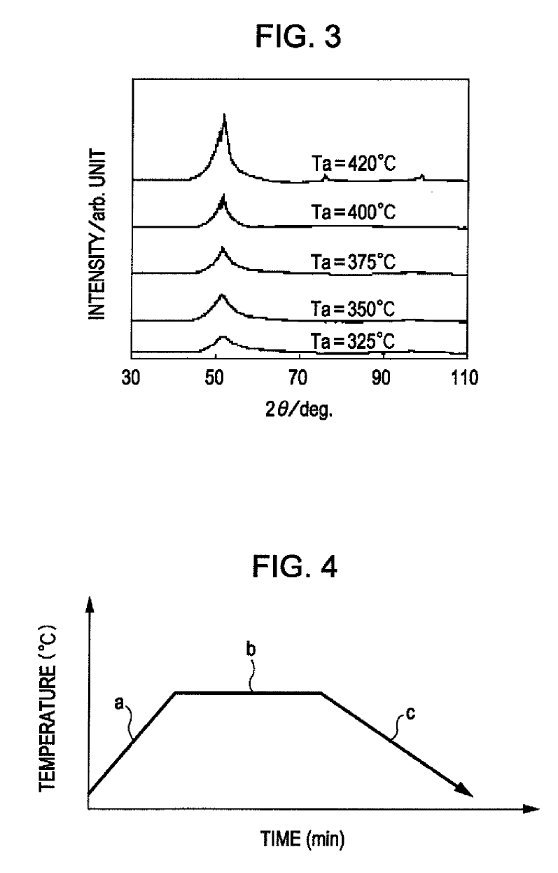

Then, as shown in FIG. 2G, the sheet 26 after the pressing is put into an annealing furnace 28 for annealing. That is, the magnetic material formed into the sheet 26 is annealed. The annealing temperature is adjusted to a temperature of approximately the glass-transition temperature or approximately the crystallization temperature of the soft magnetic alloy as the magnetic material. This annealing is a treatment for producing crystallites in the amorphous phase of the soft magnetic alloy as the magnetic material, and the annealing temperature is suitably set according to the magnetic material contained in the magnetic sheet to be annealed. That is, the annealing temperature may be a temperature which is sufficient for producing crystallites consisting mainly of bcc-Fe in the amorphous phase of the magnetic material, for example, a temperature of approximately the glass-transition temperature or approximately the crystallization temperature of the magnetic material. For example, FIG. 3 shows X-ray diffraction patterns when a magnetic sheet of a soft magnetic Fe_{69.9}Ni₆Cr₄P_{9.8}C_{7.3}B₂Si₁ alloy (Tg: about 422° C.) as the magnetic material was annealed at different annealing temperatures. It is confirmed from FIG. 3 that a peak of crystallization appears at an annealing temperature (Ta) of 350° C., and the peak becomes significant at a Ta of about 375° C. However, when the annealing temperature is higher than about 400° C., peaks of other compound phases appear. The tendency becomes significant when the annealing temperature is about 420° C. Therefore, when a soft magnetic alloy having the above-mentioned composition is used, the annealing temperature is preferably about 350 to about 400° C., more preferably about 350 to about 375° C. Further, the annealing temperature should be set not to deteriorate the resin used as the matrix material in view of heat resistance and the like of the matrix material.

The temperature profile in the annealing is adjusted to, for example, a profile shown in FIG. 4. That is, the temperature profile contains a temperature-increasing process (for example, about 10° C./min, indicated by a in the figure), a temperature-maintaining process (indicated by b in the figure), and a furnace-cooling process (indicated by c in the figure). The temperature profile is not limited to this. The similar effect can be achieved as long as the area of a temperature profile as shown in FIG. 4 is approximately the same, even if the temperature-increasing rate and the temperature-maintaining time are optionally changed. Further, the annealing is preferably carried out under an anaerobic atmosphere in view of the oxidation of the powder and deterioration of the matrix material.

The crystallites are deposited in the amorphous phase of the magnetic material by predeterminedly annealing the magnetic sheet. For example, when the magnetic material is a Fe-based soft magnetic alloy, crystallites of bcc-Fe or consisting mainly of bcc-Fe are deposited. With this, a magnetic sheet having magnetic characteristics which are different from a conventional one can be obtained. That is, this magnetic sheet can achieve a different μ′/μ″—F (real part of complex magnetic permeability/imaginary part of complex magnetic permeability—frequency). Specifically, the magnetic sheet can increase the real part μ″ of complex magnetic permeability at up to about 10 MHz and the imaginary μ″ of complex magnetic permeability at about 200 to about 300 MHz. Particularly, since the imaginary μ″ of complex magnetic permeability at about 200 to about 300 MHz can be thus increased, the noise-absorbing effect at about 200 to about 300 MHz can be achieved.

Next, an Example conducted for clarifying the effects of the present invention will be described. A soft magnetic alloy of Fe_{69.9}Ni₆Cr₄P_{9.8}C_{7.3}B₂Si₁ was formed into powder by a water atomization method to produce flat amorphous soft magnetic alloy particles. Then, about 100 parts by weight of this Fe-based amorphous soft magnetic alloy particles were put into a stirring vessel 21 shown in FIG. 2A together with about 12 parts by weight of a silicone resin functioning as a binder and about 260 parts by weight of toluene functioning as a solvent. Then, as shown in FIG. 2B, this stirring vessel 21 was mounted on a planetary stirring defoaming device 22, and the slurry adjustment was carried out by mixing and defoaming the slurry.

Then, as shown in FIG. 2C, the slurry 24 for forming a sheet was applied onto a release film 23 of an ethylene tetrafluoride resin with a doctor blade 25 and then dried for curing. With this, a sheet 26 was formed on the release film 23 as shown in FIG. 2D. Then, as shown in FIG. 2E, the sheet 26 was peeled off the release film 23. Then, as shown in FIG. 2F, the thus prepared sheet 26 was hot-pressed with a pressing machine 27. The pressing conditions were about 150° C., about 250 kg/cm², and about 30 min. Then, as shown in FIG. 2G, the obtained sheet 26 by the pressing was put into an annealing furnace 28 and annealed at about 375° C. under a nitrogen atmosphere for changing the μ″-F characteristic of the soft magnetic alloy particles. The temperature profile of this case was a temperature-increasing rate of about 10° C./min and a maintaining time of about 30 min. Then, the sheet was subjected to furnace-cooling. Thus, the magnetic sheet according to the Example was obtained.

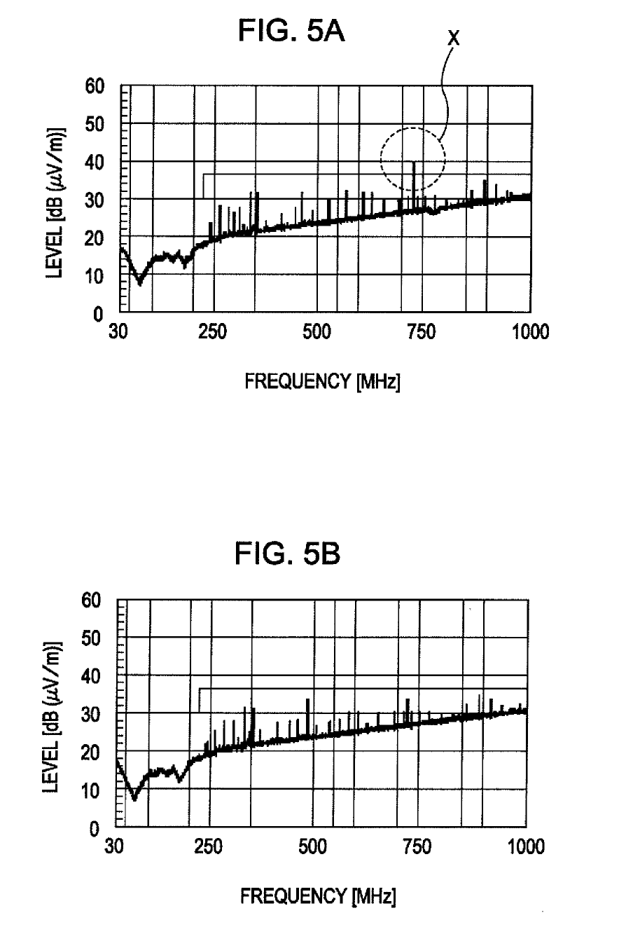

The thus obtained magnetic sheet was mounted on a digital still camera. The digital still camera was evaluated in accordance with the specification of VCCI (Voluntary Control Council for Interference by Information Technology Equipment) class B. The evaluation was carried out by a 3 m method in a radio wave darkroom. FIG. 5B shows the results. In addition, a digital still camera not mounted with the magnetic sheet was similarly evaluated for reference. FIG. 5A shows the results. These evaluations were conducted at an AC power of about 100V/50 Hz, a temperature of about 21.8° C., and a humidity of about 62.8%.

As obvious from FIGS. 5A and 5B, in the digital still camera not mounted with the magnetic sheet (FIG. 5A), the noise level was high overall, and a noise level (X part) exceeding a reference value was observed at near 700 MHz. On the other hand, in the digital still camera mounted with the magnetic sheet according to the present invention (FIG. 5B), the noise level was low overall in the measured frequency range. Thus, it was confirmed that the magnetic sheet according to the present invention has achieved a noise-suppressing effect.

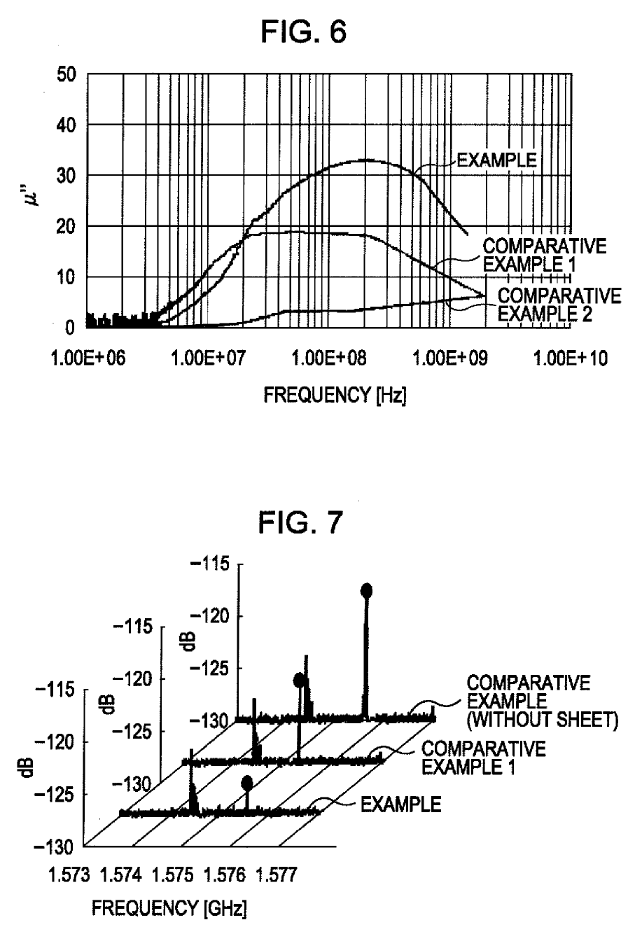

Further, the imaginary part μ″ of complex magnetic permeability was determined as a magnetic characteristic of the magnetic sheet. FIG. 6 shows the results. In addition, as comparative example 1, a magnetic sheet was produced by using an Fe—Al—Si alloy as the magnetic material and polyethylene chloride as the matrix material. The μ″ of this magnetic sheet was determined similarly as in the above. The results are shown in FIG. 6. Further, as comparative example 2, a magnetic sheet was produced by using an Fe—Al—Si-based alloy as the magnetic material and polyethylene chloride as the matrix material. The μ″ of this magnetic sheet was also determined similarly as in the above. The results are shown in FIG. 6. The magnetic sheets of comparative examples 1 and 2 were each produced by kneading the magnetic material and the matrix material and forming it into a sheet. The imaginary part μ″ of complex magnetic permeability was measured using a sheet with a thickness of about 1 mm by E4991A manufactured by Agilent.

As obvious from FIG. 6, the μμ of the magnetic sheet according to the present invention (Example) was stably high in the measured frequency range. On the other hand, the μ″ of the magnetic sheet of comparative example 1 was low at the higher-frequency band in the measurement range. The μ″ of the magnetic sheet of comparative example 2 was low in the measured frequency range. Thus, it was confirmed that the magnetic sheet according to the present invention stably achieved a high μ″ in a range from MHz to GHz bands.

Further, the thus obtained magnetic sheet according to the present invention was mounted on a CPU clock of a car navigation system, and its noise level was investigated. The results are shown in FIG. 7. In addition, a car navigation system not mounted with the magnetic sheet was similarly investigated for its noise level, for reference. The results are shown in FIG. 7. Further, a car navigation system mounted with the magnetic sheet of the above-mentioned comparative example 1 was similarly investigated for its noise level. The results are shown in FIG. 7. The measurement of the noise level was conducted by a 3 m method in a radio wave darkroom.

As obvious from FIG. 7, in the car navigation system mounted with the magnetic sheet according to the present invention (Example), the noise was attenuated and thereby the noise level was very low. This is thought that since the μ″ of the magnetic sheet is high, the ability to convert noise to heat is high. On the other hand, in the car navigation system not mounted with the magnetic sheet (without sheet), the noise level was very high. In addition, in the car navigation system mounted with the magnetic sheet of comparative example 1, the noise was slightly attenuated, but the noise level was still high. Thus, it was confirmed that the magnetic sheet according to the present invention achieved a noise-suppressing effect in a range from MHz to GHz bands.

The present invention is not limited to the above-described example, and various modifications can be made. For example, the types and contents of the constituents, blending order, and treatment conditions may be variously modified without departing from the scope of the present invention.

What is claimed is:

1. A magnetic sheet comprising:
a matrix material; and
a magnetic material disposed in the matrix material, wherein the magnetic material comprises crystallites in an amorphous phase in a relatively smaller amount than that of the amorphous phase.

2. The magnetic sheet according to claim 1, wherein the crystallites are produced by annealing the magnetic material at a temperature of approximately the glass-transition temperature or approximately the crystallization temperature of the material constituting the magnetic material.

3. The magnetic sheet according to claim 1, wherein the magnetic material is an Fe-based soft magnetic alloy.

4. The magnetic sheet according to claim 1, wherein the crystallite phase is bcc-Fe or consists mainly of bcc-Fe.

5. A method of producing a magnetic sheet, the method comprising:
a process of producing a magnetic material comprising an amorphous phase;
a process of producing a magnetic sheet comprising the magnetic material; and
a process of producing crystallites in the amorphous phase by annealing the magnetic sheet at a temperature of approximately the glass-transition temperature or approximately the crystallization temperature of the magnetic material.

6. The method of producing a magnetic sheet according to claim 5, wherein the magnetic material comprising the amorphous phase is produced by a water atomization method.

7. The method of producing a magnetic sheet according to claim 5, wherein the magnetic sheet is produced by preparing a mixture solution by mixing the magnetic material in a liquid matrix material for constituting the magnetic sheet and then forming the mixture solution into a sheet.

8. The method of producing a magnetic sheet according to claim 5, wherein the annealing is a process for depositing a crystallite phase being bcc-Fe or consisting mainly of bcc-Fe.

9. The method of producing a magnetic sheet according to claim 5, wherein the annealing is conducted at about 325 to about 400° C.

10. The method of producing a magnetic sheet according to claim 5, wherein the annealing is conducted at about 350 to about 375° C.

11. A device having a noise-suppressing effect comprising:
a magnetic sheet, the magnetic sheet comprising a matrix material; and a magnetic material disposed in the matrix material, wherein the magnetic material comprises crystallites in an amorphous phase in a relatively smaller amount than that of the amorphous phase.

12. The device according to claim 11, wherein the crystallites are produced by annealing the magnetic material at a temperature of approximately the glass-transition temperature or approximately the crystallization temperature of the material constituting the magnetic material.

13. The device according to claim 11, wherein the magnetic material is an Fe-based soft magnetic alloy.

14. The device according to claim 11, wherein the crystallite phase is bcc-Fe or consists mainly of bcc-Fe.
